(19) United States
(12) Patent Application Publication
(10) Pub. No.: US 2024/0405437 A1
(43) Pub. Date: Dec. 5, 2024

(54) ULTRA-WIDEBAND, MULTI-MODE, LOW-PROFILE, ENDFED ANTENNA

(71) Applicant: BAE SYSTEMS Information and Electronic Systems Integration Inc., Nashua, NH (US)

(72) Inventors: David P. Charette, Hudson, NH (US); Daniel L. Fontaine, Hudson, NH (US)

(73) Assignee: BAE SYSTEMS Information and Electronic Systems Integration Inc., Nashua, NH (US)

(21) Appl. No.: 17/877,013

(22) Filed: Jul. 29, 2022

(51) Int. Cl. H01Q 9/04; H01Q 13/08

(52) U.S. Cl. CPC H01Q 9/0485; H01Q 13/08

(57) ABSTRACT

A low profile, broadband radiator operates as a dielectric rod antenna (DRA) but is conformally mounted to a conducting sheet along its axis of symmetry. The new device exploits the imaging theory of electromagnetics to split the DRA in half while maintaining its full-height TEM feed, HE₁₁ waveguide, and radiation taper characteristics. The disclosed device is attractive for applications requiring directed energy on or near the axis of the antenna, i.e. ‘end-fire’, and for high shock and velocity environments. Bandwidth extension is realized by adding one or more cores of higher dielectric material and by modifying the feed and mode formation regions. A second polarization is generated by configuring the feed for odd-mode transmission and creating a flared notch radiator within a metallized split launcher.

### FIELD OF THE DISCLOSURE

The following disclosure relates generally to antenna design and fabrication and, more specifically, to the design of wideband, low-profile, end-fire radiating antennas suitable for conformal mounting to conducting surfaces.

### BACKGROUND

High bandwidth communications and data transfer capabilities that can operate over a wide frequency range are crucial in the modern world, especially in combat situations where traditional communication links are unlikely to be available.

A variety of RF/microwave antenna types exist that achieve multi-octave bandwidth across segments of the 100 MHz to 100 GHz frequency range. Examples include cavity backed two and four-arm spirals, Vivaldi notch radiators, and multi-layer dielectric rod antennas. Some of these antennas are suitable for conformal mounting to conductive surfaces, but have their peak radiation direction normal to the mounting surface. In applications such as aircraft, belly-mounted antennae are configured to see directly ahead or directly behind the host aircraft, however, it would be desirable for the antenna to be both suitable for conformal mounting to conductive surfaces and to radiate most of its energy ‘end-fire’, that is, in a direction parallel to the mounting surface.

What is needed, therefore, is a wideband, conformally mounted antenna that radiates most of its energy in a direction parallel to the mounting surface, preferably one that is relatively low-profile and that can survive direct exposure to high shock and high-velocity environments that may be encountered, for instance, on an aircraft.

### SUMMARY

Disclosed herein is an adaptation to the well-established dielectric rod antenna (DRA), a type of surface wave antenna, that applies electromagnetic image theory to realize a wideband, end-fire antenna for low-profile, conformal applications. By combining an imaged, uniform thickness section of a DRA (see Dielectric Image Line) with an imaged transverse electromagnetic (TEM) feed, and an imaged radiation taper, significant performance benefits are obtained.

An overview of the prior art's working principles is given and then applied to the disclosure. Methods are described for extending bandwidth through structural and feed mechanism enhancements. A means of incorporating a second operating mode that radiates with a polarization orthogonal to the primary mode is also presented.

Implementations of the approach described above may include a method or process, a system or apparatus, a kit, or computer software stored on a computer-accessible medium. The details or one or more implementations are set forth in the accompanying drawings and the description below. Other features will be apparent from the description and drawings, and from the claims.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIG. 1 is a schematic showing a prior art DRA with a TEM horn feed;

FIG. 2 is a schematic showing a prior art TEM horn feed;

FIG. 3A is a DRA with a TEM horn feed which has been dissected across its plane of symmetry, mounted to a conductive ground plane and ‘squared-off’ for ease of manufacturing, which is herein referred to as a ‘dielectric wedge radiator’, in accordance with embodiments of the present disclosure;

FIG. 3B is a cross sectional view of the feed section of the dielectric wedge radiator shown in FIG. 3A;

FIG. 3C is an end view of the dielectric wedge radiator shown in FIG. 3A;

FIG. 3D is a side elevation view of the dielectric wedge radiator shown in FIG. 3A;

FIG. 4A is a two-layer, dielectric wedge radiator configured for extended bandwidth operation, in accordance with embodiments of the present disclosure;

FIG. 4B is a cross-sectional view of the two-layer, dielectric wedge radiator of FIG. 4A for extended bandwidth operation;

FIG. 5 shows electromagnetic field control structures in a mode transition region, in accordance with embodiments of the present disclosure;

FIG. 6 shows launch modifications for extending lower frequency operations, in accordance with embodiments of the present disclosure;

FIGS. 7A and 7B depict top and side views, respectively, of an even-odd mode feed arrangement for exciting dual polarization, in accordance with embodiments of the present disclosure; and

FIGS. 8A and 8B depict top and side views of a nested arrangement comprising one wedge radiator within another of different dielectric material to extend operating bandwidth, in accordance with embodiments of the present disclosure.

These and other features of the present embodiments will be understood better by reading the following detailed description, taken together with the figures herein described. The accompanying drawings are not intended to be drawn to scale. For purposes of clarity, not every component may be labeled in every drawing.

### DETAILED DESCRIPTION

As a preliminary matter, as used herein, image theory and related terminology should be understood to refer to the theory that states that for antennas mounted over or near a ground plane (a very large, perfectly conducting plane), virtual sources (images) can be place below the ground plane to account for reflections from the ground plane. After introducing the properly arranged image sources, the electromagnetic field above the ground plane can be considered as a sum of the electromagnetic fields, due to the real sources (above the ground plane) and the image sources (below the ground plane), with the ground plane removed. This image theory can only be applied above the ground plane, but not below the ground plane; below the ground plane, the electromagnetic field is strictly zero.

Furthermore, as used herein, ‘imaged’ means cutting an original structure in half and attaching an electrical conductor to the split plane to maintain the same fields above the split as were present with the original structure.

Still further, modes of electromagnetic radiation are used herein to describe the field pattern of the propagating waves and are analogous to the normal modes of vibration in other systems, such as mechanical systems. Specifically in the case of hybrid electromagnetic (HEM) modes, both the electric and magnetic fields have a component in the direction of propagation. They can be analyzed as a linear superposition of transverse electric (TE) and transverse magnetic (TM) modes.

Now referring to the present disclosure, the present disclosure teaches new, wideband, multi-mode, end-fed, low-profile, end-firing antenna designs that can be mounted conformally to a metallic body, or ground plane.

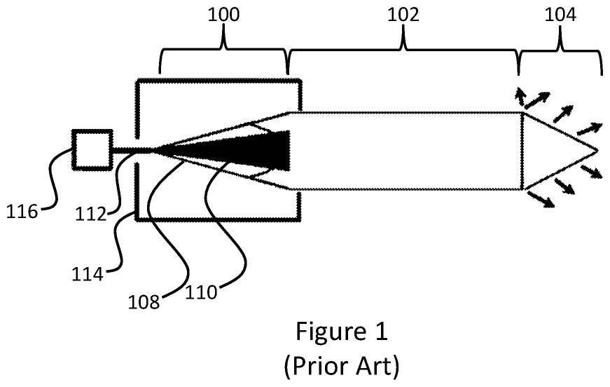

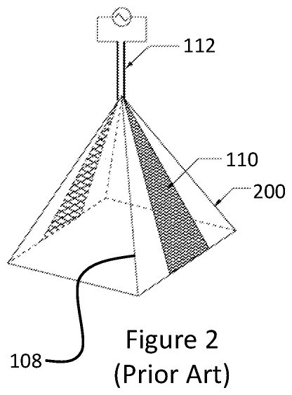

FIGS. 1 and 2 show a prior art, circular cross-section dielectric rod antenna (DRA) having a feed region 100 comprising a TEM horn 108 having a launcher 110 disposed thereon, the launcher being connected to a coaxial or two-line wire feed 112. Such a DRA is made of a dielectric material 200 and operates by exciting, from an end of the DRA comprising the feed region 100, a fundamental hybrid magnetic-electric mode (HE₁₁) in a constant-diameter region of the DRA, herein referred to as a guide section 102, and then tapering the DRA down, within a radiation region 104, to promote radiation of a guided wave from a terminal portion of the radiation region 104. FIG. 1 additionally shows a shielding structure 114 and balun 116.

HE₁₁ mode excitation is commonly achieved by tapering the feed region 100 of the DRA comprising the TEM horn 108 and applying a two-wire line feed 112, such as a pair of strip conductors or differential twin strip feed, to a launcher 110 disposed on the tapered surfaces of the TEM horn 108, with the separation between the conductors gradually growing to the full DRA diameter. By exciting each of the wires of the two-wire line feed 112 180 degrees out of phase in an ‘odd-mode’ or ‘differential’ arrangement, the predominant electric field orientation is in a plane containing the center lines of the wires. If the flare angle is relatively small and the length of the tapered portion of the feed region 100 is a guided wavelength or more, then the excited field in the feed region 100 will be approximately transverse electromagnetic (TEM) and this will effectively excite the desired HE₁₁ mode in the uniform rod section, i.e. the guide section 102. This mechanism of inducing a particular mode may be referred to as the launch method. The field polarization of the fundamental mode and the radiated energy is defined by the orientation of the two-wire line feed 112, as described above. This radiated energy has its peak amplitude along the axis of the DRA and is referred to herein as an ‘end-fire’ configuration.

The bandwidth over which the uniform portion of the DRA, i.e. the guide section 102, carries only the fundamental HE₁₁ mode can be defined as f_{high}-f_{low}, where f_{high} corresponds to the guide wavelength that is approximately equal to the DRA diameter within the guide section 102 and where f_{low} is that frequency where the impedance mismatch of the feed reaches 2:1 Voltage Standing Wave Ratio (VSWR). At lower frequencies, the launcher 110 becomes electrically too short and ineffectively excites the HE₁₁ mode in the rod. At frequencies above f_{high}, higher order modes form on the DRA, corrupting the resulting radiation patterns. The operating bandwidth of a practical TEM-fed, uniform DRA is approximately 2:1, e.g. 2-4 GHz.

In general, the fields of the HE₁₁ mode exist both within the guide section 102 of the DRA and in the surrounding air region. The higher the frequency of operation, the more the fundamental mode fields concentrate within the guide section 102 of the DRA and have their wave velocity slowed by the dielectric 200. At lower frequencies, or when the DRA diameter is reduced, the fields extend more in the air region outside the DRA and the wave velocity approaches that of air. At the limit, when the DRA diameter becomes very small, relative to the guide wavelength, the wave detaches completely from the DRA and radiates; this is why the radiation region 104 of embodiments is tapered to nearly a point. The length of the radiation region 104 impacts directivity of the DRA. A short radiation region 104 will have relatively low directivity while the phasing up of progressive radiation across a longer radiation region 104 increases directivity.

The DRA described above works satisfactorily when there are no conducting bodies in the immediate vicinity of the antenna. However, if this antenna were situated within a wavelength of a conducting body, such that a long side of the guide section 102 was parallel to the conducting surface, serious field disruptions would be expected in the feed region 100, He₁₁/guide sections 102, and radiation regions 104.

According to features of the present description, to avoid this disruption in applications where a broadband, end-fire antenna is needed on the skin of a conducting body, embodiments herein exploit the image theory of electromagnetics and place one half of the DRA directly on a conducting ground plane 300, such embodiments being herein referred to as wedge radiators.

The aforementioned imaged embodiments functions because, assuming the conducting ground plane 300 extends to infinity in all directions and the full-rod geometry and feed is split along the plane of magnetic symmetry (i.e. the DRA is sliced in half, with a half disposed directly on the conducting ground plane 300), then the field pattern in the space containing the half-rod geometry will be identical to the full-rod case without a conducting ground plane 300. Unfortunately, in practice the conducting ground plane 300 is finite sized and the radiating fields diffract somewhat at the boundaries of the ground conductor, creating deviation in the radiation pattern from that of the un-imaged case. This deviation is typically acceptable, however, if the ground plane termination is at least a few wavelengths away from the antenna extent.

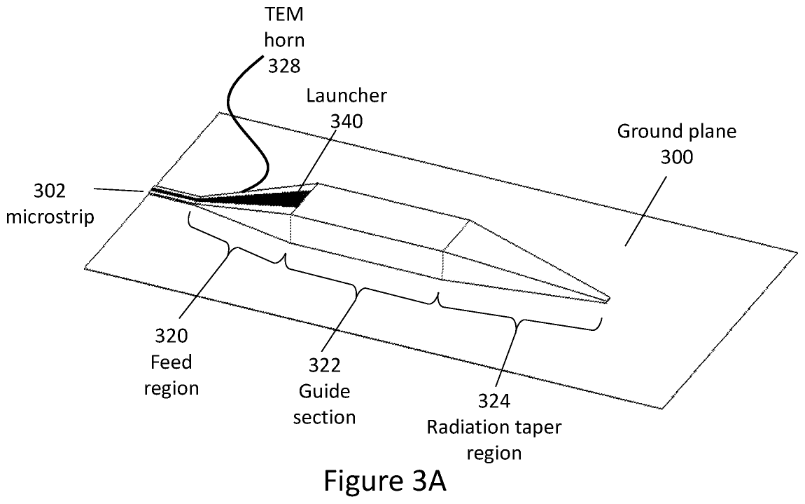

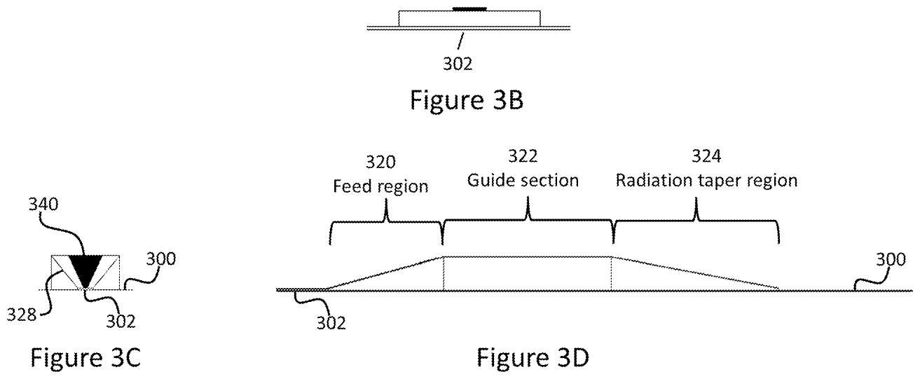

FIGS. 3A, 3B, 3C, and 3D show a manufacturing-friendly faceted embodiment of a wedge radiator in accordance with embodiments of the present disclosure. In other embodiments, the DRA geometry is imaged without faceting, resulting in a smooth outer surface. The wedge radiator, in embodiments, has a wedge shape and is designed to be affixed to or otherwise placed on a conducting ground plane 300, at least during use. Because this antenna design is now half the thickness of conventional designs and its long dimension is conformal to a mounted surface, it is considered to be ‘low-profile’.

Given its similar geometry to existing DRAs, the imaged wedge radiator of FIGS. 3A, 3B, 3C, and 3D operates much like the DRA in the feed region 320, He₁₁ mode/guide section 322, and the radiation taper region 324, as described above. In realizing the wedge radiator, embodiments replace the differential two-wire line feed 112 with a conventional ‘single-ended’ microstrip transmission line 302, which is used broadly in RF design, although other designs, including a conventional two-wire line feed, could be used without departing from the inventive scope of the present disclosure.

FIGS. 3A, 3B, 3C, and 3D show a section of uniform thickness microstrip transmission line 302 leading up to a tapered feed region 320 comprising a TEM horn 328 having a launcher 340 disposed thereon. This uniform thickness segment is only for convenience in connecting to other microstrip lines 302 and devices. The launcher 340 may be excited at its narrow-height beginning and will achieve the same effect.

As with the DRA, the primary electric field polarization of the He₁₁ mode and the final radiation pattern are determined by the feed polarization, which is normal to the image ground plane. Consistent with the DRA, there are many parameters available in the wedge radiator design to establish the required performance, such as the TEM horn 328 length, launcher 340 length, microstrip transmission line 302 final width, He₁₁ mode region/guide section 322 length & thickness, radiation taper region 324 length, radiation taper region 324 minimum thickness, the dielectric constant of the dielectric 350, and others, as would be known to one of ordinary skill in the art. A three-dimensional electromagnetic field solver is an effective means of assessing and optimizing the performance of a given design.

To achieve an operating bandwidth greater than 2:1, multiple layers of dielectric 350 are incorporated in the structure of embodiments, with each layer being referred to herein as a core 400 or core dielectric 400. Cores, as used herein, should be understood to refer to blocks of material, of any suitable geometry, that are contained, at least partially, within an antenna in accordance with embodiments of the present disclosure.

The fields of the fundamental He₁₁ mode will concentrate toward the center of a DRA, also referred to as central portion, if it has a core component comprising one or more cores of relatively higher dielectric constant material. This action of the fields increases fundamental-mode bandwidth by constraining higher frequency energy to the core dielectric 400, as long as the guide wavelength remains greater than the core 400 diameter. When the guide wavelength drops below the core 400 diameter, higher order modes become possible. In principle, adding a properly designed core dielectric 400 doubles the operating bandwidth and enables a two-layer antenna to operate with predominant, fundamental mode fields over a 4:1 frequency range.

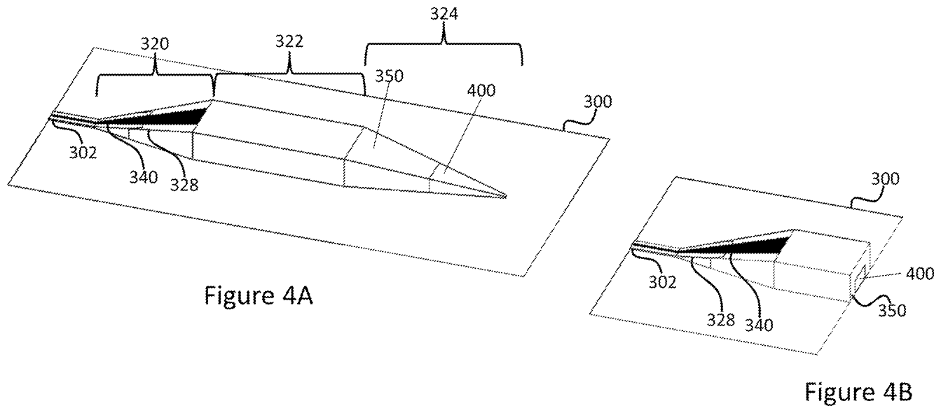

FIGS. 4A and 4B show this two-layer dielectric 350/400 concept as applied to the wedge radiator. The dynamics of the feed region 320, TEM horn 328, launch 340, guide section 322, and the radiation taper regions 324 remain largely the same as in the uniform dielectric device when appropriate values are selected for the core geometry and core dielectric 400 dielectric material 350 constant. In embodiments, additional core dielectric 400 layers are included to further expand frequency coverage and create an ultra-wideband radiator with 8:1 bandwidth or more.

The following points address modifications and variations to the single layer wedge radiator that could also be applied to multi-layer instantiations.

The TEM mode created in the feed region 320 effectively excites the fundamental He₁₁ mode when the latter is tightly coupled to the dielectric 350 body of the wedge radiator, which occurs at higher frequencies in the operating band. At lower frequencies, the He₁₁ mode is more loosely coupled to the dielectric 350 body of the wedge radiator and greater mode mismatch is produced at the end of the microstrip feed 302. This mechanism results in reflections in the microstrip feed 302 and the lower limit of the operating band.

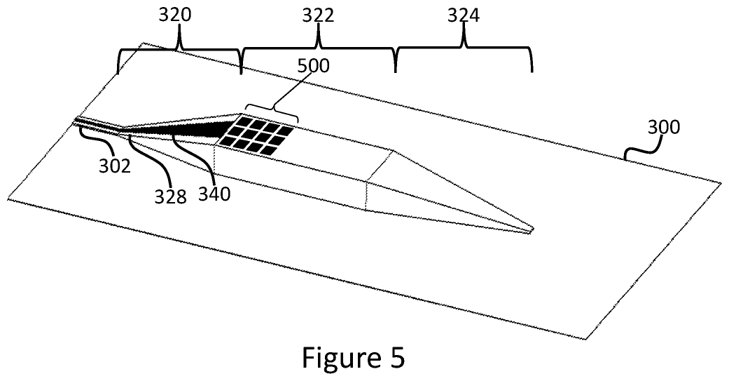

FIG. 5 shows an approach to effectively extend the feed region 320 to promote more effective conversion to the fundamental He₁₁ mode and operation lower in frequency. In such embodiments, conductive or resistive elements 500, which may be in the form of strips, structures, or the like, are placed on the dielectric body 350 within the guide section 322, adjacent the feed region 320. These conductive or resistive elements 500 may be connected to each other and the launcher 340 with resistive or conductive strips, left unconnected, or connected with capacitive or inductive structures. They are intended to suppress or attenuate higher order modes stimulated at the end of the launcher 340 and to draw more feed energy into the He₁₁ mode.

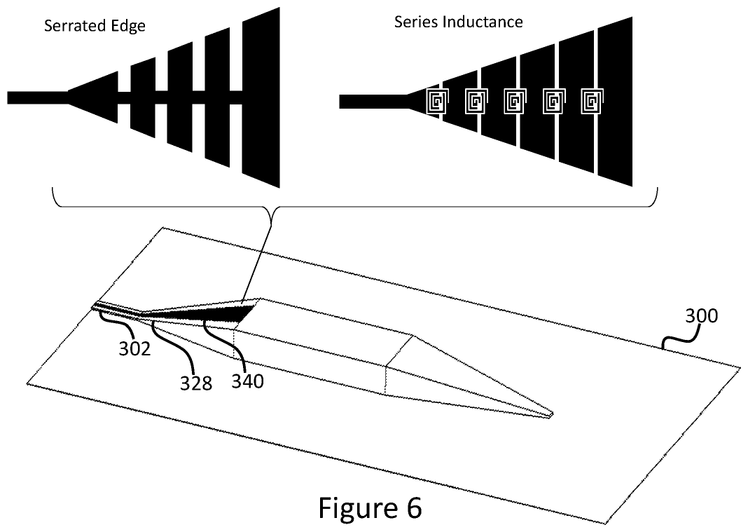

In a similar vein, FIG. 6 shows concepts for electrically lengthening the feed region 320 to achieve operation at lower frequencies. More specifically, edge serrations in the launcher 340 force the currents passing through the launcher 340 to take a longer path, especially for lower frequency waves which need the full launcher 340 length to transition the TEM mode to HE₁₁. Higher frequency waves experience greater TEM to He₁₁ mode conversion earlier in the launcher 340 and are not impacted as much by the serrations or the open-ended, capacitive launch termination. Another, similar mechanism for achieving lower frequency extension uses series inductive elements connected to segments of the launcher 340. The inductors are printed on a thin dielectric substrate above the launcher 340 and connected with plated through holes or by 3D machining techniques. Other circuit elements, such as capacitors and resistors, may be added to this region as with the mode guiding section 322 to extend bandwidth or to create a resonant, narrow-bandwidth impedance match below the main operating band, such as shown in FIG. 5.

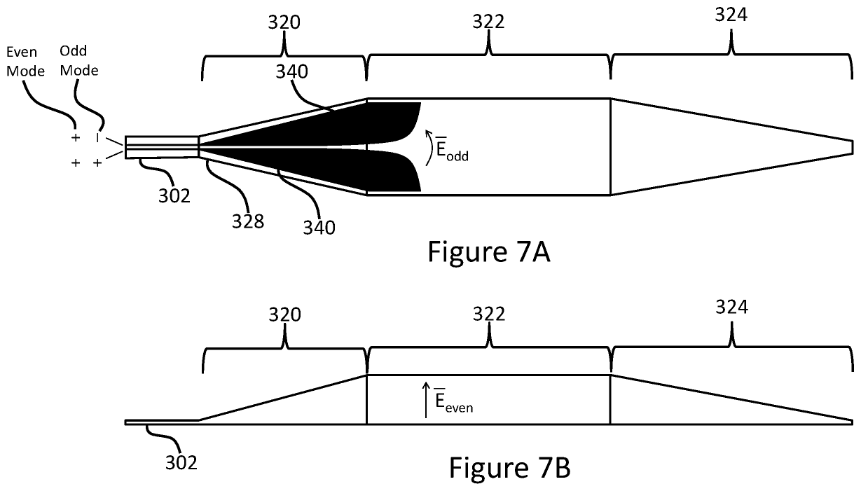

To this point in the description of the wedge antenna, the polarization of the radiated field has been normal to a conducting ground plane 300. Applications exist that would benefit from a polarization perpendicular to this. FIGS. 7A and 7B teach embodiments providing a dual polarized antenna by implementing an even-odd mode two line wire or strip feed 302. When stimulated with equal amplitude and equal phase signals, the strip feed 302, which, in embodiments is a co-planar strip feed, will excite the TEM mode in the launcher 340 and the He₁₁ mode in the guide section/antenna body 322, as described above. However, when the co-planar strip feed 302 is excited 180 degrees out of phase, an odd-mode or ‘differential’ excitation of the launcher 340 is created. If the gap between the launcher 340 is designed properly and is flared at the end, as depicted in FIGS. 7A and 7B, this differential feed 302 will excite a Vivaldi notch type of radiation, which has a field polarization in the plane of the flared strip segments of the launcher 340. The multi-mode operation of this antenna, in embodiments, is enabled by using a 180 degree hybrid circuit, e.g. ‘rat-race’ coupler, connected to the co-planar strip feed lines.

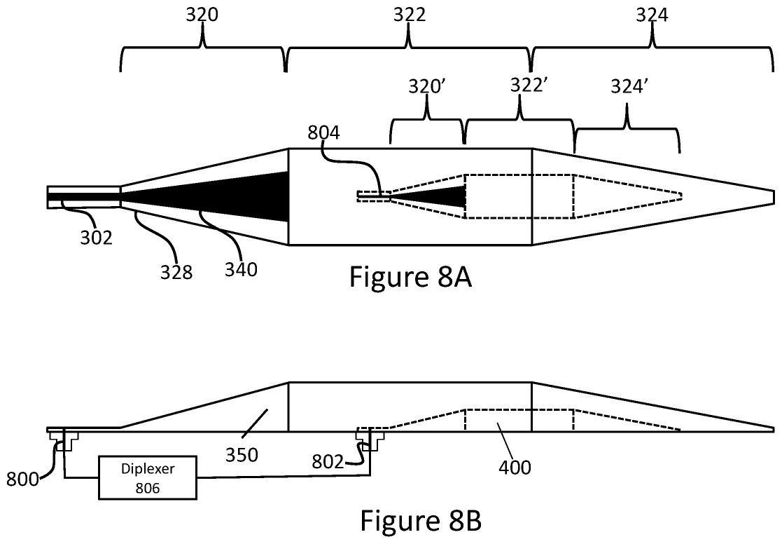

Lastly, FIGS. 8A and 8B teach embodiments that provide extended bandwidth by embedding an antenna, in embodiments a uniform dielectric wedge antenna in accordance with the teachings of the present disclosure, within another, with the embedded antenna utilizing a higher dielectric constant dielectric 400 than the host antenna. More specifically, one exemplary embodiment, which is shown in FIGS. 8A and 8B, disposes a small wedge antenna that comprises a feed region 320′, guide section 322′, and radiation taper region 324′ within a relatively larger wedge antenna such that a portion of the guide section 324′ of the small wedge antenna lies within the guide section 322 and a portion lies within the radiation taper region 324 of the relatively larger wedge antenna.

In such embodiments, the higher dielectric constant 400 of the embedded, relatively smaller wedge antenna creates a material discontinuity at its interface with the relatively larger host wedge antenna that supports an electromagnetic wave mode along the guide section 322′ and radiation taper region 324′, in the same manner as the air to dielectric boundary of the host wedge antenna. The embedded wedge antenna of such embodiments operates higher in frequency than the host wedge antenna, given the first order principle that antenna operation scales inversely with size (i.e. mode excitation and conduction are dependent on the antenna's geometry, relative to operating wavelength).

Notably, the frequency increase of the embedded wedge antenna does not scale in a 1:1 manner with size because the higher dielectric makeup of the embedded wedge 400 and its non-air boundary environment, the portion of the guide section 322 and radiation taper region 324 of the host wedge antenna adjacent to the embedded wedge antenna, allows a longer wavelength (e.g. a lower frequency) to exist on the guide section 322′ and radiation taper region 324′ of the embedded wedge antenna than would be possible with the host dielectric material 350 and its air boundary environment. For at least these reasons, the embedded wedge antenna is able to operate over a range of frequencies that overlaps with the host wedge antenna, with some part of the frequency range above that of the host wedge antenna's own range and some within that range.

Furthermore, the embodiment of the host wedge antenna shown in FIG. 8A and 8B is depicted as having an underside connection 800 coupling to a microstrip 302, whereas the smaller wedge antenna includes an underside connection 802 coupled to its own microstrip 804. The means of connection depicted is a coaxial type, in embodiments of typically 50 Ohm characteristic impedance, with its center conductor extending through the microstrip 302 and contacting the microstrip 302, although other types of connections and connectors could be used.

In embodiments, different feed lines excite the host wedge connector 800 and the embedded wedge connector 802 at different frequencies.

In embodiments, a diplexer 806 is used to take a single feed line, in embodiments a broadband feed line, and divert higher frequency signals on it to the embedded wedge antenna's underside connection 802 and lower frequency signals to the host wedge connector's underside connection 800. In this way, the embedded wedge embodiment of FIGS. 8A and 8B enjoys a wider frequency of operation than the baseline embodiment of FIG. 3.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

What is claimed is:

1. A dielectric rod antenna, comprising:
a feed region, a guide section, and a radiation region,
wherein the feed region comprises an imaged TEM horn having a launcher disposed thereon, the launcher being in communication with a feed and configured to excite a HE₁₁ fundamental guided wave on the guide section,
wherein the guide section is located between the feed region and the radiation region and has a guide section thickness that is substantially a constant thickness,
wherein the radiation region is disposed adjacent the guide section and has a radiation region thickness that tapers down from the guide section thickness along its length,
wherein the radiation region is configured to radiate the guided wave, and
wherein the dielectric rod antenna is configured to be disposed on and coupled to a conducting ground plane.

2. The antenna of claim 1, further comprising one or more cores of a relatively higher dielectric constant material than that of the dielectric body and embedded within the dielectric rod antenna.

3. The antenna of claim 2, wherein each of said one or more cores is of a successively higher dielectric constant material, relative to a previous, enveloping layer of material.

4. The antenna of claim 1, further comprising conductive elements disposed on a top surface of the guide section, wherein a bottom surface of the guide section is configured to be disposed on and coupled to the conducting ground plane.

5. The antenna of claim 1, further comprising resistive, capacitive, or inductive elements disposed on a surface of the guide section proximate the launcher.

6. The antenna of claim 5, wherein the resistive, capacitive, or inductive elements are connected to each other and to the launcher with one or more resistive or conductive strips, left unconnected, or connected with one or more capacitive or inductive structures.

7. The antenna of claim 1, wherein the feed comprises a strip conductor.

8. The antenna of claim 7 wherein the strip conductor comprises a differential twin strip feed, coax, or a single-ended microstrip transmission line.

9. The antenna of claim 1, wherein the dielectric rod antenna is an imaged dielectric rod antenna.

10. The antenna of claim 1 wherein the dielectric rod antenna has a rectangular cross section.

11. The antenna of claim 10 wherein top, bottom, right, and left faces of the antenna are substantially planar.

12. The antenna of claim 1 wherein at least a portion of a top surface of said TEM horn is metallized.

13. The antenna of claim 1 wherein the launcher is split into two or more launcher segments.

14. The antenna of claim 13 wherein two launcher segments are stimulated in an odd mode by a split microstrip feed to form a Vivaldi notch radiator.

15. The antenna of claim 1, further comprising a second, smaller dielectric rod antenna disposed within the antenna.

16. The antenna of claim 15 wherein the second smaller dielectric rod antenna has a higher dielectric constant than the antenna and is disposed in a same orientation.

17. The antenna of claim 15, wherein the antenna further comprises an underside connection in communication with the feed, wherein the second, smaller dielectric rod antenna disposed within the antenna comprises its own underside connection in communication with a second feed, and further comprising at least two feed lines each in electrical communication with either the antenna or the second, smaller dielectric rod antenna, each of the two feed lines being configured to excite either the antenna or the second, smaller dielectric rod antenna.

18. The antenna of claim 15, wherein the antenna further comprises an underside connection in communication with the feed, wherein the second, smaller dielectric rod antenna disposed within the antenna comprises its own underside connection in communication with a second feed, and further comprising a diplexer in electrical communication with the feed and second feed, wherein the diplexer is in electrical communication with a single feed line and configured to divert higher frequency signals on the single feed line to the second feed and lower frequency signals to the feed.

19. An end-fed antenna, the antenna comprising:
an imaged dielectric rod antenna with a dielectric body comprising an imaged feed region, an imaged guide section, an imaged radiation region, and one or more imaged cores of a relatively higher dielectric constant material,
wherein the imaged feed region comprises a TEM horn having a launcher disposed thereon, the launcher being in communication with a feed and configured to excite a HE₁₁ fundamental guided wave on the imaged guide section disposed adjacent thereto,
wherein the imaged guide section is located between the imaged feed region and the imaged radiation region and has a guide section thickness that is substantially a constant thickness,
wherein the imaged radiation region has a radiation region thickness that tapers down from the imaged guide section thickness along its length,
wherein the imaged radiation region is configured to radiate the guided wave,
wherein said one or more imaged cores increases in dielectric constant as they are more centrally located, and
wherein the dielectric body is configured to be disposed on and coupled to a conducting ground plane.

20. An end-fed antenna, the antenna comprising:
an imaged dielectric rod antenna including a dielectric body comprising a feed region, a guide section, and a radiation region, wherein a bottom surface of the dielectric body is disposed on and coupled to a conducting ground plane; and
one or more conductive, resistive, capacitive, or inductive elements disposed on a top surface of the guide section,
a TEM horn within the feed region having a launcher disposed thereon, the launcher being in communication with a feed and configured to excite a He₁₁ fundamental guided wave on the guide section disposed adjacent thereto,
wherein the guide section is located between the feed region and the radiation region and has a guide section thickness that is substantially a constant thickness,
wherein the radiation region has a radiation region thickness that tapers down from the guide section thickness along its length,
wherein the radiation region is configured to radiate the guided wave,
wherein the resistive, capacitive, or inductive elements are connected to each other and to the launcher with resistive or conductive strips, wherein the resistive or conductive strips are left unconnected, or connected with capacitive or inductive structures,
wherein the launcher is split into at least two launcher segments, and
wherein a gap between the launcher segments is gradually increased to form a Vivaldi notch radiator configured to operate when the feed is stimulated in an odd mode and wherein equal phase stimulus of said launcher segments is configured to generate fundamental mode radiation with polarization normal to the conducting ground plane while out of phase stimulus is configured to excite a Vivaldi radiation mode with polarization parallel to the conducting ground plane.
